(19) United States
(12) Patent Application Publication
(10) Pub. No.: US 2021/0095870 A1
(43) Pub. Date: Apr. 1, 2021

(54) PERSONALIZED AIR CLEANING DEVICE

(71) Applicant: AIRLABS BV, Amsterdam (NL)

(72) Inventors: Carl MEUSINGER, Copenhagen (DK); Reza ANSARISHIRVAN, KGS Lyngby (DK); Sophie POWER, London (GB); Siamak ARDKAPAN, Copenhagen (DK); Sertan Østergaard Saltan CHRISTOFFERSEN, Copenhagen (DK); Amelia STROHSNITTER, Copenhagen (DK); Matthew JOHNSON, Lund (SE)

(73) Assignee: AIRLABS BV, Amsterdam (NL)

(21) Appl. No.: 16/499,508

(22) PCT Filed: Mar. 29, 2018
(86) PCT No.: PCT/EP2018/058067

§ 371 Date: Sep. 30, 2019

(30) Foreign Application Priority Data
Mar. 30, 2017 (EP) 17163739.0

(51) Int. Cl. F24F 1/035; B60H 3/06; F24F 3/16; F24F 13/06

(52) U.S. Cl. CPC F24F 1/035; B60H 3/0608; F24F 2120/10; F24F 13/06; F24F 2003/1614; F24F 3/1603

(57) ABSTRACT

The present disclosure relates to a diffuser module having an inlet and an outlet for use in connection with a) an air cleaning unit having an inlet and an outlet, wherein the inlet is adapted to receive ambient air and the outlet is adapted to disperse the cleaned air, and a housing containing the air cleaning unit, b) an air cooling unit having an inlet and an outlet, wherein the inlet is adapted to receive ambient air and the outlet is adapted to disperse the cooled air, and a housing containing the air cooling unit, or c) both a) and b), wherein the inlet of the diffuser module is connected to the outlet of the air cleaning unit and/or the air cooling unit and the outlet of the diffuser module is adapted to direct the cleaned air and/or the cooled air to a specified zone.

### FIELD OF THE INVENTION

The present invention relates to a stand-alone air cleaning device for an enclosed space such as a car cabin. Furthermore, the present invention concerns an air cooling device for providing cleaned air to a specified zone. Moreover, the present invention concerns an air cleaning device for providing cleaned air to a specified zone. Furthermore, the present invention concerns a diffuser module for use in connection with an air cleaning unit and/or an air cooling unit or both.

### BACKGROUND OF THE INVENTION

Air pollutants, particularly nitrogen dioxide (NO₂) and fine particulate matter (PM_{2.5}), represent considerable threats to human health. As an example, an estimated 40,000 premature deaths per year are linked to exposure to poor quality air in the UK and the resulting cost to the UK's businesses, society, and health services, adds up to more than £20 billion per year.

A large proportion of these premature deaths can be attributed to nitrogen dioxide, which is produced primarily as a result of combustion processes, with vehicle exhaust emissions being the main source of NO₂ in urban settings. The adverse effects of NO₂ on human health are well documented, and include irritation of the airways, impaired lung function, aggravation of pre-existing asthma, and an increased susceptibility to respiratory infections. The annual mean limit set by the EU is 40 μg/m³ and the mean concentration limit for NO₂ as an hourly average is 200 μg/m³.

Fine particulate matter (PM_{2.5}), is a blanket term to describe any particle with an aerodynamic diameter of 2.5 microns or less. These particles are particularly harmful, as their small size allows them to penetrate deep into the lungs, and in some cases even diffuse into the bloodstream. Particulate matter can consist of a wide variety of components, including acids, organics, metals, and common soil and dust particles, and as such it can produce a multitude of harmful effects on the body when inhaled. Exposure to high concentrations is strongly linked to cardiovascular and cerebrovascular disease. Particulate matter is also known to result in increased respiratory mortality and morbidity due to inflammation and oxidative damage, and long term exposure can result in decreased lung function, increased susceptibility to disease, and exacerbation of pre-existing conditions. In comparison to the larger, less harmful PM₁₀ fraction, the annual mean PM_{2.5} concentration limit is much lower, at 10 μg/m³.

Air purifiers remove pollution such as NO₂ and PM_{2.5}. They mainly comprise a fan, one or more filters and a box for housing the fan and the filter. Many filtration methods are known such as mechanical filtration, gas phase advanced oxidation (GPAO, reference EP 08388017.9) adsorption and electrostatic filtration and different methods are suitable for different removal tasks.

People in closed spaces, such as car cabins are exposed to polluted air, from traffic, cooking, industry, and other sources. Existing air purifiers clean either the exhaust of a polluting process or they clean the whole room/area people are in, but there have not been any systems to clean the air in such spaces and provide clean air specifically to people.

### SUMMARY OF THE INVENTION

The present invention concerns a diffuser module having an inlet and an outlet for use in connection with a) an air cleaning unit having an inlet and an outlet, wherein the inlet is adapted to receive ambient air and the outlet is adapted to exit, that is disperse, the cleaned air, and a housing containing the air cleaning unit, b) an air cooling unit having an inlet and an outlet, wherein the inlet is adapted to receive ambient air and the outlet is adapted to disperse the cooled air, and a housing containing the air cooling unit, or c) both a) and b), wherein the inlet of the diffuser module is connected to the outlet of the air cleaning unit and/or the air cooling unit and the outlet of the diffuser module is adapted to direct the cleaned air and/or the cooled air to a specified zone.

The invention provides cleaned air to one or more users and may for instance be used in car cabins for providing cleaned air to the driver and optional passengers. With multiple diffuser modules cleaned air can reach multiple passengers and the driver when driving in polluted areas, such as cities. Multiple outlets can also help reduce the airflow out of one diffuser and thereby making the driver and/or passenger feel more comfortable, such as less breezy and avoid the draft experience. A preferred embodiment of the diffuser module uses a curved and narrowing channel with finned outlets to direct the output of the cleaning and/or cooling stage towards people without causing excessive noise or pressure drop, with an even uniform flow that does not cause discomfort.

In an embodiment of the diffuser module of the present invention, the air cleaning unit comprises a gas phase advanced oxidation (GPAO) and/or a filter and a means for driving air over the GPAO and/or the filter, wherein the GPAO and/or filter is adapted to clean ambient air.

In another embodiment of the diffuser module of the present invention, the air cooling unit comprises a cooling element and a means for driving air over the cooling element, wherein the cooling element is adapted to cool ambient air.

In a further embodiment of the diffuser module of the present invention, the air cleaning unit comprises a means for driving air over a filter and a filter, wherein the filter is adapted to clean ambient air, and wherein the air cooling unit comprises a means for driving air over a cooling element and a cooling element, wherein the cooling element is adapted to cool ambient air.

In a further embodiment of the diffuser module of the present invention, the specified zone is a human breathing zone.

In a still further embodiment of the diffuser module of the present invention the outlet of the diffuser module comprises at least two different air channels adapted to direct cleaned air streams to the specified zone. Typically, from 2 to 10 air channels.

In a further embodiment of the diffuser module of the present invention, the module comprises a curved and narrowing air channel with fins for directing the cleaned air stream via the air channels to the specified zone.

In a still further embodiment of the diffuser module of the present invention, the air channels comprise at least two fins to help direct the air stream.

The role of the air channel is multiple. That is, to direct the clean air where it is needed, for example to people or passengers; to be able to direct the airflow without causing discomfort due to too high air velocity, therefore the air flow must be uniform and not of excessive velocity (people do not like air pushing on their face); to direct the uniform and low-velocity air flow without causing noise or excessive pressure drop. The curved and narrowing channel shown in the drawings shows a specific and preferred embodiment of the air channel. The narrowing makes sure the dispersed airflow remains even. The curve makes sure the size can be more compact. In addition, preferably, the channels have fins to help direct the air flow. As used herein the term “curved and narrowing channel” means a channel for transporting air wherein the channel forms a curve that may continue curving to become a circular or partly circular channel, but as a minimum is one curve starting with a broad diameter and ending with a more narrow diameter, hence the narrowing of the curve.

In a further aspect, the present invention relates to an air cleaning device for providing cleaned air to a specified zone comprising

a) a housing containing an air cleaning unit having an inlet and an outlet, wherein the inlet is adapted to receive ambient air and the outlet is adapted to disperse the cleaned air, and
b) a diffuser module having an inlet and an outlet,
wherein the inlet of the diffuser module is connected to the outlet of the air cleaning unit, and the outlet of the diffuser module is adapted to direct the cleaned air to the specified zone.

In an embodiment of the air cleaning device of the present invention the outlet of the diffuser module is adapted to direct the cleaned air to the specified zone without inducing high pressure drop or excessive noise. This is due to the curved and narrowing air channel.

In another embodiment of the air cleaning device of the present invention, the air cleaning unit comprises a filter and a means for driving air over the filter, wherein the filter is adapted to clean ambient air.

In a further embodiment of the air cleaning device of the present invention, the specified zone is a human breathing zone.

In a still further embodiment of the air cleaning device of the present invention, further comprising a sensor for monitoring motion and adjust or activate the air cleaning device when needed.

In a further embodiment of the air cleaning device of the present invention, the air cleaning unit is capable of cleaning polluted air comprising exhaust gases, such as NOx and SOx, ultrafine particles, ozone, particulate matter, volatile organic compounds, urban pollutants and naturally occurring compounds. NOx may without limitation be selected from a group consisting of NO and NO₂, and SOx may without limitation be selected from SO, SO₂, SO₃, S₇O₂, S₆O₂, and S₂O₂).

In a still further embodiment of the air cleaning device of the present invention, the air cleaning unit comprises a means for transporting air flows, such as a fan or wind power.

In a further embodiment of the air cleaning device of the present invention, the air cleaning unit comprises a gas phase advanced oxidation (GPAO) or a filter, such as a filter selected from the group consisting of an active carbon filter, a gas adsorbing filter, an electrostatic filter, a honeycomb filter, a sponge based filter, and a fabric filter.

In a still further embodiment of the air cleaning device of the present invention, the air cleaning unit comprises at least two different filters, wherein one filter is a filter for removing gases and the other filter is a filter for removing particulate matter.

In a further embodiment of the air cleaning device of the present invention, the air cleaning unit comprises at least two different filters, wherein one filter is a filter for removing NOx and the other filter is a filter for removing nanoparticles or ultrafine particles.

In a further embodiment of the air cleaning device of the present invention, the diffuser module is adapted to provide cleaned air extending up to 2 m, such as from 0.1-2 m, in different directions from the outlet of the diffuser module hereby creating the specified zone.

In a still further embodiment of the air cleaning device of the present invention, further comprising a sensor for monitoring ambient air pollution, clean air or both, with an associated control unit that is able to activate and adjust the air cleaning device when needed.

In a further embodiment of the air cleaning device of the present invention, the sensor is located inside the housing containing the air cleaning unit.

In a still further embodiment of the air cleaning device of the present invention, the device is a stand-alone device.

In a further embodiment of the air cleaning device of the present invention, the device is a personalized device.

In a still further embodiment of the air cleaning device of the present invention, the device is adapted to a car cabin and deliver cleaned air to the whole car cabin.

In a further embodiment of the air cleaning device of the present invention, the device is adapted to a car cabin and deliver cleaned air to the breathing zone of a driver and/or a passenger. A typical air cleaning device is attached to or integrated in a head rest of a car seat.

In a still further embodiment of the air cleaning device of the present invention the device is adapted to a cabin for smoking.

In a still further embodiment of the air cleaning device of the present invention, the diffuser module is an integrated part of the air cleaning unit, or the diffuser module is remote from the air cleaning unit and connected via an air tight means of connection, such as plastic tubes.

In a further embodiment of the air cleaning device of the present invention, the ambient air to be cleaned comprises emissions from traffic, industrial sites (power plants, paint shops, sewage treatment plants, tunnels, air terminals, harbors, ferry terminals), construction sites, natural sources (fires, dust storms), occupational air pollution loads that include hazardous and non-hazardous concentrations of pollution, such as high H₂S concentrations, or high VOC concentrations.

In a still further embodiment of the air cleaning device of the present invention, the air cleaning unit has at least 2 outlets, and a diffuser module is connected to each outlet, providing at least 2 diffuser modules.

In a further embodiment of the air cleaning device of the present invention, the air cleaning unit has from 2-10 outlets, and a diffuser module is connected to each outlet, providing from 2-10 diffuser modules.

In a still further embodiment of the air cleaning device of the present invention, the diffuser module is adjustable and adapted to point in any suitable direction.

In a further aspect, the present invention concerns a personalized air cleaning device comprising

i) an air cleaning device for providing cleaned air to a specified zone comprising
a) a housing containing an air cleaning unit having an inlet and an outlet, wherein the inlet is adapted to receive ambient air and the outlet is adapted to disperse the cleaned air, and
b) a diffuser module having an inlet and an outlet,
wherein the inlet of the diffuser module is connected to the outlet of the air cleaning unit, and the outlet of the diffuser module is adapted to direct the cleaned air to the specified zone; and
   ii) a head cover;
   wherein the diffuser module and optionally the air cleaning device is an integrated part of the cover.

In an embodiment of the personalized air cleaning device of the present invention, the diffuser module comprises a curved and narrowing air channel for directing the cleaned air stream via the air channels to the specified zone. This is to i.a. minimize noise and pressure drop.

As used herein the term “head cover” means an item to be worn on the head and/or neck of a person. In another embodiment of the personalized air cleaning device of the present invention, the head cover is selected from the group consisting of a motorbike helmet, clothing, a scarf, stole, bonnet, collar, hijab, burqa, hat or face mask, or a jacket with a collar.

In a still further aspect, the present invention concerns a personalized air cleaning device comprising

i) an air cleaning device for providing cleaned air to a specified zone comprising
a) a housing containing an air cleaning unit having an inlet and an outlet, wherein the inlet is adapted to receive ambient air and the outlet is adapted to disperse the cleaned air, and
b) a diffuser module having an inlet and an outlet,
wherein the inlet of the diffuser module is connected to the outlet of the air cleaning unit, and the outlet of the diffuser module is adapted to direct the cleaned air to the specified zone; and
   ii) a movable car seat adapted to receive a child;
   wherein the diffuser module and optionally the air cleaning device is an integrated part of the child car seat.

In an embodiment of the personalized air cleaning device of the present invention, the diffuser module comprises a curved and narrowing air channel for directing the cleaned air stream via the air channels to the specified zone. This is to i.a. minimize noise and pressure drop.

In another embodiment of the personalized air cleaning device of the present invention, the diffuser module is adjustable and adapted to point in any suitable direction.

In a still further aspect, the present invention concerns an air cooling device for providing cool air to a specified zone comprising

a) a housing containing an air cooling unit having an inlet and an outlet, and
b) a diffuser module having an inlet and an outlet,
wherein the inlet of the diffuser module is connected to the outlet of the air cooling unit, and the outlet of the diffuser module is adapted to direct the cooled air to the specified zone.

In an embodiment of the air cooling device of the present invention, the diffuser module comprises a curved and narrowing air channel for directing the cleaned air stream via the air channels to the specified zone. This is to i.a. minimize noise and pressure drop.

In another embodiment of the air cooling device of the present invention, the air cooling unit comprises a cooling element and a means for driving air over the cooling element, wherein the cooling element is adapted to cool ambient air.

In another embodiment of the air cooling device of the present invention, the diffuser module is adjustable and adapted to point in any suitable direction.

In a further aspect, the present invention concerns a stand-alone air cleaning device for a cabin, such as a car cabin, comprising a housing containing an air cleaning unit having a) an inlet and an outlet, wherein the inlet is adapted to receive ambient air and the outlet is adapted to disperse the cleaned air, and b) a means for driving the ambient air over at least two filters, wherein one filter is a filter for removing NOx and the other filter is a filter for removing nanoparticles and/or ultrafine particles.

The air cleaning unit of the present invention will remove ultrafine particles and gas pollutants and then will direct the cleaned air to the breathing zone of the relevant person such as a passenger and/or a driver. The unit will need much less energy when it is at personalized mode and therefore will cause very low noise which will be more comfortable for the user. Using sensors, it will be possible to turn change from personalized mode to generalized mode.

The present invention provides these advantages with the described solution.

Further objects and advantages of the present invention will appear from the following description, and claims.

### DESCRIPTION OF THE INVENTION

The invention provides cleaned air to one or more users and may for instance be used in car cabins for providing cleaned air to the driver and optional passengers. With multiple diffuser modules cleaned air can reach multiple passengers and the driver when driving in polluted areas, such as cities. Multiple outlets can also help reduce the airflow out of one diffuser and thereby making the driver and/or passenger feel more comfortable by avoiding unpleasant drafts. For instance, in a car cabin, optional manual input or sensors can switch the air cleaner between different modes, one of which is a personalized mode for one person/driver and the other mode for cleaning air in the whole cabin/for several people/passengers and the driver, or one mode for quickly cleaning high pollution levels and another for maintaining clean conditions.

The present invention concerns a diffuser module having an inlet and an outlet for use in connection with a) an air cleaning unit having an inlet and an outlet, wherein the inlet is adapted to receive ambient air and the outlet is adapted to disperse the cleaned air, and a housing containing the air cleaning unit, b) an air cooling unit having an inlet and an outlet, wherein the inlet is adapted to receive ambient air and the outlet is adapted to disperse the cooled air, and a housing containing the air cooling unit, or c) both a) and b), wherein the inlet of the diffuser module is connected to the outlet of the air cleaning unit and/or the air cooling unit and the outlet of the diffuser module is adapted to direct the cleaned air and/or the cooled air to a specified zone.

One invention concerns a diffuser module having an inlet and an outlet for use in connection with a) an air cleaning unit having an inlet and an outlet, wherein the inlet is adapted to receive ambient air and the outlet is adapted to disperse the cleaned air, and a housing containing the air cleaning unit, wherein the inlet of the diffuser module is connected to the outlet of the air cleaning unit and the outlet of the diffuser module is adapted to direct the cleaned air to a specified zone.

Another invention relates to a diffuser module having an inlet and an outlet for use in connection with an air cooling unit having an inlet and an outlet, wherein the inlet is adapted to receive ambient air and the outlet is adapted to disperse the cooled air, and a housing containing the air cooling unit, wherein the inlet of the diffuser module is connected to the outlet of the air cooling unit and the outlet of the diffuser module is adapted to direct the cooled air to a specified zone.

In an embodiment of the diffuser module of the present invention, the air cleaning unit comprises a gas phase advanced oxidation (GPAO) and/or a filter and a means for driving air over the GPAO and/or the filter, wherein the GPAO and/or filter is adapted to clean ambient air.

In another embodiment of the diffuser module of the present invention, the air cooling unit comprises a cooling element and a means for driving air over the cooling element, wherein the cooling element is adapted to cool ambient air.

In a further embodiment of the diffuser module of the present invention, the air cleaning unit comprises a means for driving air over a filter and a filter, wherein the filter is adapted to clean ambient air.

In a still further embodiment of the diffuser module of the present invention, the air cooling unit comprises a means for driving air over a cooling element and a cooling element, wherein the cooling element is adapted to cool ambient air.

In a further embodiment of the diffuser module of the present invention, the specified zone at the outlet of the diffuser module is a human breathing zone.

In a further aspect, the present invention relates to an air cleaning device for providing cleaned air to a specified zone comprising

a) a housing containing an air cleaning unit having an inlet and an outlet, wherein the inlet is adapted to receive ambient air and the outlet is adapted to disperse the cleaned air, and
b) a diffuser module having an inlet and an outlet,
wherein the inlet of the diffuser module is connected to the outlet of the air cleaning unit, and the outlet of the diffuser module is adapted to direct the cleaned air to the specified zone.

The term “a housing” as used herein is a shield, such as a cabinet covering the air cleaning unit or the air cooling unit.

The term “a specified zone” as used herein means a zone of cleaned air surrounding the outlet of the diffuser module which can be adjusted according to the desired purpose. The size of the diffuser outlet(s) and speed of the cleaned air coming out can be adjusted to create a small zone or larger zone of cleaned air, such as to provide cleaned air extending up to 2 m in different directions from the outlet of the diffuser module hereby creating the specified zone.

The term “an air cleaning unit” as used herein means a unit that is configured to draw air into the unit wherein the air is cleaned from pollution, such as by leading the air through a filter removing the pollution or part of the pollution, and then typically via a diffuser module is emitted out of the device, for instance by means of a fan, wind power or similar means. Typical construction of such air cleaning units is known to the skilled person. The air cleaning unit is adapted to receive current from for instance a power cable.

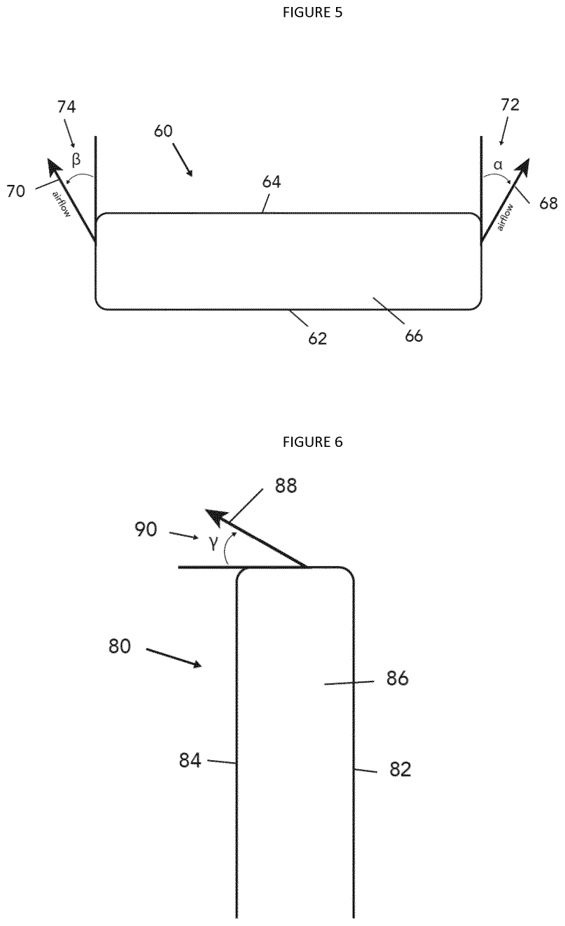

The term “a diffuser module” as used herein means a module that may have any shape and size, but where the outlet is adapted, such as via a nozzle, to blow air into a zone surrounding the outlet of the diffuser module. Preferably the diffuser module is adjustable and adapted to point in any suitable direction. Typically, the diffuser module is adapted to provide cleaned air wherein the cleaned air leaves the outlet of the diffuser module in a flow direction at an angle that is less than 180 degree relative to the flow direction of the ambient air into the inlet of the air cleaning device. A particular explanation of this aspect is given in relation to the description of FIGS. 5 and 6.

The term “a movable car seat adapted to receive a child” as used herein means a car seat that may be placed on the seat of a car, such as a child car seat. Such a car seat is movable and can be removed from the car when no small children are being transported, and be inserted when a child too small to sit on a regular car seat is being transported by the car.

In an embodiment of the air cleaning device of the present invention, the air cleaning unit comprises a filter and a means for driving air over the filter, wherein the filter is adapted to clean ambient air.

In a further embodiment of the air cleaning device of the present invention, the specified zone at the outlet of the diffuser module is a human breathing zone.

In a still further embodiment of the air cleaning device of the present invention, further comprising a sensor to activate and/or adjust the air cleaning device when needed. Typical sensors are metal oxide, electrochemical, light absorption and light scattering. In a further embodiment of the air cleaning device of the present invention, a first sensor is for detecting the level of air pollution and a second sensor is for detecting a person. Typical example of the first sensor is an electrochemical sensor, such as for detecting NO₂. Typical example of the second sensor is an optical sensor, such as for detecting movements. Furthermore, the air cleaning device of the present invention may have a switch configured to make the device operate in a general mode or a personalized mode.

In a further embodiment of the air cleaning device of the present invention, the air cleaning unit is capable of cleaning polluted air comprising exhaust gases, such as NOx and SOx, ultrafine particles, ozone, particulate matter, volatile organic compounds, urban pollutants and naturally occurring compounds. In particular, in the air cleaning device of the present invention, the air cleaning unit is capable of cleaning polluted air comprising NOx and SOx, and ultrafine particles, such as NO₂ and ultrafine particles.

As used herein the term “ultrafine particles” means particles smaller than 300 nm in mean mass aerodynamic diameter (MMAD). The term “nanoparticles” is used interchangeably with ultrafine particles.

As used herein the term “fine particles” means particles larger than 300 nm and smaller than 3 micrometers in MMAD.

In a still further embodiment of the air cleaning device of the present invention, the air cleaning unit comprises a means for transporting air flows, such as a fan or wind power. Preferably, the means for transporting air flows is a fan.

In a further embodiment of the air cleaning device of the present invention, the air cleaning unit comprises a gas phase advanced oxidation (GPAO) or a filter, such as a filter selected from the group consisting of an active carbon filter, chemically modified graphene filter, a gas adsorbing filter, an electrostatic filter, a honeycomb filter, a sponge based filter, and a fabric filter.

In a still further embodiment of the air cleaning device of the present invention, the air cleaning unit comprises at least two different filters, wherein one filter is a filter for removing NOx, such as NO₂, and the other filter is a filter for removing nanoparticles or ultrafine particles.

In a further embodiment of the air cleaning device of the present invention, the diffuser module is adapted to provide cleaned air extending up to 2 m, such as from 0.1-2 m, in different directions from the outlet of the diffuser module hereby creating the specified zone.

In a further embodiment of the air cleaning device of the present invention, the diffuser module is adapted to provide cleaned air wherein the cleaned air leaves the outlet of the diffuser module in a flow direction at an angle that is less than 90 degree relative to the direction of flow of the ambient air into the inlet of the air cleaning device. In a further embodiment, the angle is from 10 to 80 degrees. In a still further embodiment, the angle is from 15 to 70 degrees. In a further embodiment, the angle is from 15 to 60 degrees, such as from 15 to 30 degrees. The particular angle from 15 to 30 degrees, provides a particular high cleaning of the ambient air as shown by the results presented herein.

In a further embodiment of the air cleaning device of the present invention, the diffuser module is adapted to provide cleaned air wherein the cleaned air leaves the outlet of the diffuser module in a flow direction at an angle that is less than 180 degree relative to the direction of flow of the ambient air into the inlet of the air cleaning device. In a further embodiment, the angle is from 120 to 150 degrees. In a still further embodiment, the angle is from 140 to 160 degrees.

In a still further embodiment of the air cleaning device of the present invention, further comprising a sensor for monitoring ambient air pollution, clean air or both and adjust or activate the air cleaning device when needed.

In a further embodiment of the air cleaning device of the present invention, the sensor is located inside the housing containing the air cleaning unit.

In a still further embodiment of the air cleaning device of the present invention, the device is a stand-alone device.

The term “stand-alone” as used herein means a device which can be transported by the user and plugged-in at any desired place, such as in a car cabin, a cabin for smoking, an office in a building.

In a further embodiment of the air cleaning device of the present invention, the device is a personalized device.

The term “a personalized device” as used herein means a special device that is adapted to fit the person using said device. Such personalized device may be a helmet that is adapted to cover the head of a person or may be a neck airbag wherein the diffuser is integrated into or connected to the helmet or neck airbag, or may be a child car seat.

In a still further embodiment of the air cleaning device of the present invention, the device is adapted to a car cabin and deliver cleaned air to the whole car cabin.

In a further embodiment of the air cleaning device of the present invention, the device is adapted to a car cabin and delivers cleaned air to the breathing zone of a driver and a passenger

In a still further embodiment of the air cleaning device of the present invention, the device is adapted to a car cabin and delivers cleaned air to the breathing zone of a driver.

In a further embodiment of the air cleaning device of the present invention, the device is adapted to a car cabin and delivers cleaned air to the breathing zone of a passenger. A typical air cleaning device is attached to or integrated in a head rest of a car seat.

In a still further embodiment of the air cleaning device of the present invention the device is adapted to a cabin for smoking. So, a further aspect of the present invention is a cabin for smoking comprising the air cleaning device of the present invention.

In a still further embodiment of the air cleaning device of the present invention, the diffuser module is an integrated part of the air cleaning unit.

In a further embodiment of the air cleaning device of the present invention, the diffuser module is remote from the air cleaning unit and connected via an air tight connection means, such as plastic tubes.

In a further embodiment of the air cleaning device of the present invention, the ambient air to be cleaned comprises emissions from traffic, industrial sites (power plants, paint shops, sewage treatment plants, tunnels, air terminals, harbors, ferry terminals), construction sites, natural sources (fires, dust storms), occupational air pollution loads that include hazardous and non-hazardous concentrations of pollution, such as high H₂S concentrations, or high VOC concentrations.

In a still further embodiment of the air cleaning device of the present invention, the air cleaning unit has at least 2 outlets, and a diffuser module is connected to each outlet, providing at least 2 diffuser modules.

In a further embodiment of the air cleaning device of the present invention, the air cleaning unit has from 2-10 outlets, and a diffuser module is connected to each outlet, providing from 2-10 diffuser modules. Typically, the unit has from 2-5, such as 2 or 3 outlets.

In a further aspect, the present invention concerns a personalized air cleaning device comprising

i) an air cleaning device for providing cleaned air to a specified zone comprising
a) a housing containing an air cleaning unit having an inlet and an outlet, wherein the inlet is adapted to receive ambient air and the outlet is adapted to disperse the cleaned air, and
b) a diffuser module having an inlet and an outlet,
wherein the inlet of the diffuser module is connected to the outlet of the air cleaning unit, and the outlet of the diffuser module is adapted to direct the cleaned air to the specified zone; and
   ii) a head cover;
   wherein the air cleaning device is an integrated part of the cover.

The diffuser of the head cover having the air cleaning device is able to deliver air to the mouth and nose or face of a person.

In an embodiment of the personalized air cleaning device of the present invention, the head cover is selected from the group consisting of a motorbike helmet, clothing, a scarf, stole, bonnet, collar, hijab, burqa, hat or face mask, or a jacket with a collar.

In a still further aspect, the present invention concerns a personalized air cleaning device comprising

i) an air cleaning device for providing cleaned air to a specified zone comprising
a) a housing containing an air cleaning unit having an inlet and an outlet, wherein the inlet is adapted to receive ambient air and the outlet is adapted to disperse the cleaned air, and
b) a diffuser module having an inlet and an outlet,
wherein the inlet of the diffuser module is connected to the outlet of the air cleaning unit, and the outlet of the diffuser module is adapted to direct the cleaned air to the specified zone; and
   ii) a movable car seat adapted to receive a child;
   wherein the diffuser module and optionally the air cleaning device is an integrated part of the child car seat.

Any one of the embodiments of the air cleaning device of the present invention specified above either alone or in combination constitute a separate embodiment of the personalized air cleaning device of the present invention.

In a still further aspect, the present invention concerns an air cooling device for providing cool air to a specified zone comprising

a) a housing containing an air cooling unit having an inlet and an outlet, and
b) a diffuser module having an inlet and an outlet,
wherein the inlet of the diffuser module is connected to the outlet of the air cooling unit, and the outlet of the diffuser module is adapted to direct the cooled air to the specified zone.

In an embodiment of the air cooling device of the present invention, the air cooling unit comprises a cooling element and a means for driving air over the cooling element, wherein the cooling element is adapted to cool ambient air. One example of the cooling unit is a Peltier air cooling element.

In a further aspect, the present invention concerns a stand-alone air cleaning device for a cabin, such as a car cabin, comprising a housing containing an air cleaning unit having a) an inlet and an outlet, wherein the inlet is adapted to receive ambient air and the outlet is adapted to disperse the cleaned air, and b) a means for driving the ambient air over at least two filters, wherein one filter is a filter for removing NOx and the other filter is a filter for removing nanoparticles or ultrafine particles.

In an embodiment one filter is for removing NOx, such as NO₂, and the other filter is a filter for removing nanoparticles.

In a further embodiment one filter is for removing NOx, such as NO₂, and the other filter is a filter for removing ultrafine particles.

In a still further embodiment one filter is for removing NO₂, and the other filter is a filter for removing nanoparticles and ultrafine particles.

In a further embodiment means for driving the ambient air is selected from a group consisting of a fan or wind power. Typically, the means for driving the ambient air is a fan.

In a further aspect, the present invention concerns use of an air cleaning device for providing cleaned air to a specified zone comprising

a) a housing containing an air cleaning unit having an inlet and an outlet, wherein the inlet is adapted to receive ambient air and the outlet is adapted to disperse the cleaned air, and
b) a diffuser module having an inlet and an outlet,
wherein the inlet of the diffuser module is connected to the outlet of the air cleaning unit, and the outlet of the diffuser module is adapted to direct the cleaned air to the specified zone,
for providing cleaned air to the specified zone.

In a further aspect, the present invention concerns use of a personalized air cleaning device comprising

i) an air cleaning device for providing cleaned air to a specified zone comprising
a) a housing containing an air cleaning unit having an inlet and an outlet, wherein the inlet is adapted to receive ambient air and the outlet is adapted to disperse the cleaned air, and
b) a diffuser module having an inlet and an outlet,
wherein the inlet of the diffuser module is connected to the outlet of the air cleaning unit, and the outlet of the diffuser module is adapted to direct the cleaned air to the specified zone; and
   ii) a head cover;
   wherein the diffuser module and optionally the air cleaning device is an integrated part of the head cover,
   for providing cleaned air to the person.

In an embodiment of the personalized air cleaning device of the present invention, the head cover is selected from the group consisting of a motorbike helmet, clothing, a scarf, stole, bonnet, collar, hijab, burqa, hat or face mask, or a jacket with a collar.

In a further aspect, the present invention concerns a method of providing cleaned air in a specified zone comprising operating

an air cleaning device comprising

a) a housing containing an air cleaning unit having an inlet and an outlet, wherein the inlet is adapted to receive ambient air and the outlet is adapted to disperse the cleaned air, and
b) a diffuser module having an inlet and an outlet,
wherein the inlet of the diffuser module is connected to the outlet of the air cleaning unit, and the outlet of the diffuser module is adapted to direct the cleaned air to the specified zone,
for providing cleaned air to the specified zone.

In a further aspect, the present invention concerns a method of providing cleaned air to a specified zone of a person comprising operating

a personalized air cleaning device comprising

i) an air cleaning device for providing cleaned air to a specified zone comprising
a) a housing containing an air cleaning unit having an inlet and an outlet, wherein the inlet is adapted to receive ambient air and the outlet is adapted to disperse the cleaned air, and
b) a diffuser module having an inlet and an outlet,
wherein the inlet of the diffuser module is connected to the outlet of the air cleaning unit, and the outlet of the diffuser module is adapted to direct the cleaned air to the specified zone; and
   ii) a head cover;
   wherein the diffuser module and optionally the air cleaning device is an integrated part of the head cover,
   for providing cleaned air to the specified zone of the person.

The diffuser of the head cover is able to deliver air to the mouth and nose or face of a person.

In an embodiment of the personalized air cleaning device of the present invention, the head cover is selected from the group consisting of a motorbike helmet, clothing, a scarf, stole, bonnet, collar, hijab, burqa, hat or face mask, or a jacket with a collar.

The invention will now be described more fully with reference to the appended drawings illustrating typical embodiments of the diffuser module, air cleaning device and air cooling device with air cleaning devices integrated therein.

These drawings are by no means limiting the scope of the present invention and are only intended to guide the skilled person for better understanding of the present invention.

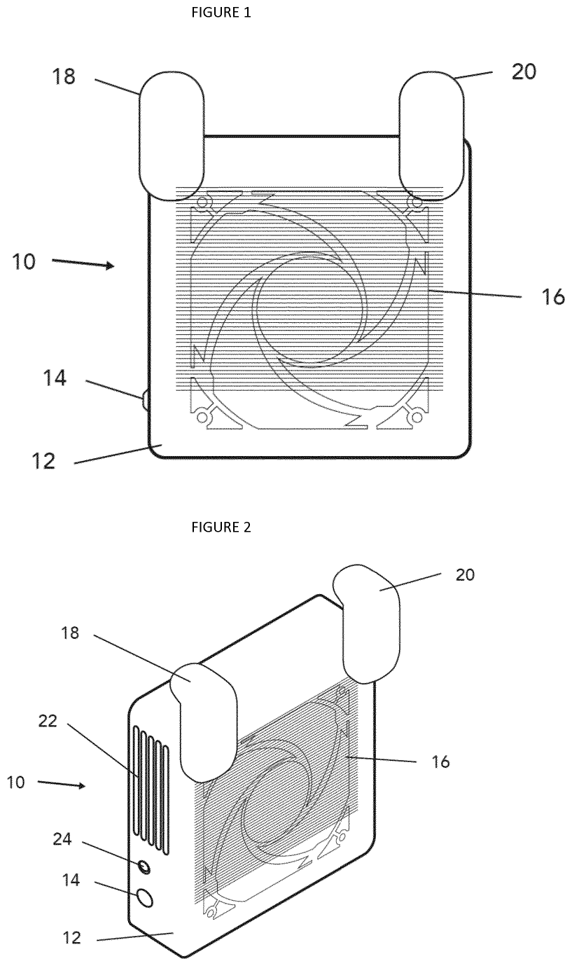

FIG. 1 illustrates a personalized air cleaning device (10) of the present invention with a cabinet (12) comprising the air cleaning unit (not shown) and having two diffusers (18, 20) connected to outlets of the air cleaning unit (not shown). The cabinet (12) has a front panel (16) for shielding the fan which is located behind the panel. The fan will draw ambient air into the air cleaning unit (not shown) and push the cleaned air out through the diffusers (18, 20). The outlets of the diffusers are pointing in a direction opposite the front panel (16) of the device, but can be used to direct the airflow in any suitable direction. A wire terminal (14) for electricity. The cabinet (12) has a front panel (16) for shielding the fan which is located behind the panel.

FIG. 2 illustrates the personalized air cleaning device (10) of FIG. 1 seen in 3D perspective with two diffusers (18, 20), the front panel (16), the cabinet (12), and the wire terminal (14). On the side of the cabinet (12) is a means for turning the device on and off (24). Furthermore, on the side of the cabinet (12) are elongated openings (22) for air to come out in case the device is not in personalized mode, which openings are typically also located on the opposite side of the cabinet (not shown).

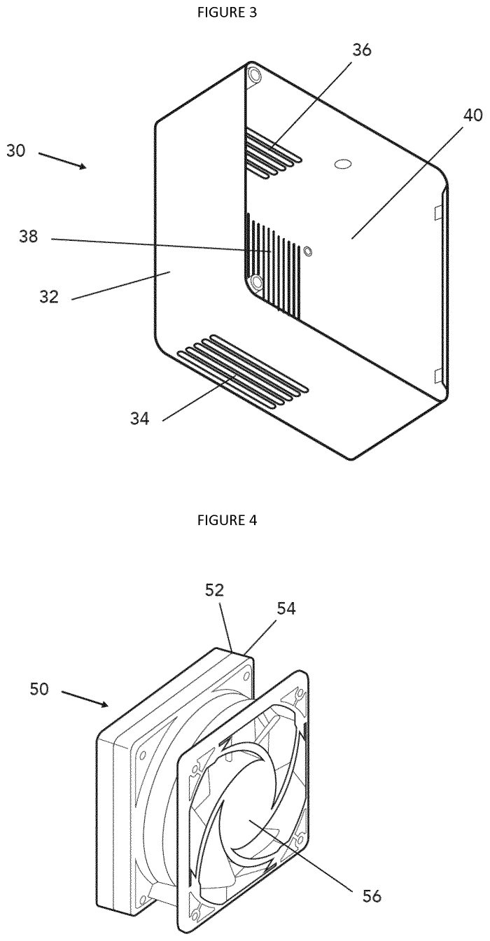

FIG. 3 illustrates a cabinet (30, 32) with a front panel (38) and two elongated openings (34, 36) on the side of the cabinet (30, 32) as well as a space (40) for housing the air cleaning unit and the fan (not shown).

FIG. 4 illustrates an air cleaning unit (50) wherein a fan (56) for drawing ambient air into and through a particle filter (54) and then a gas filter (52). The air cleaning unit is adapted to a cabinet, such as the cabinet shown in FIG. 3.

FIG. 5 illustrates an air cleaning unit (60) seen top down wherein the top is indicated by (66). The air cleaning unit (60) is typically as shown in FIGS. 1 and 2. The front (62) of the air cleaning unit (60) has an opening (not shown) for drawing ambient air into the unit (60) and is located opposite the back (64) of the air cleaning unit (60). The cleaned air is pushed out through two diffusers (not shown), located on each side of the unit (60), in a direction (68, 70) having an angle alpha (72) and an angle beta (74). The air flow out of the diffusers is adjustable and the angle alpha (72) and angle beta (74) may be the same or different and represent an angle that is less than 90° relative to the direction of the ambient air drawn into the unit (60) from the front (62) of the air cleaning unit (60).

FIG. 6 illustrates an air cleaning unit (80), which may be identical to the unit shown in FIG. 5, seen from one side (86) wherein the front (82) of the air cleaning unit (80) has an opening (not shown) for drawing ambient air into the unit (80) and is located opposite the back (84) of the air cleaning unit (80). The cleaned air is pushed out through a diffuser (not shown), located on the side of the unit (80), in a direction (88) having an angle gamma (90). The air flow out of the diffuser is adjustable and the angle gamma (90) represent an angle that is less than 90° relative to the direction of the ambient air drawn into the unit (80) from the front (82) of the air cleaning unit (80).

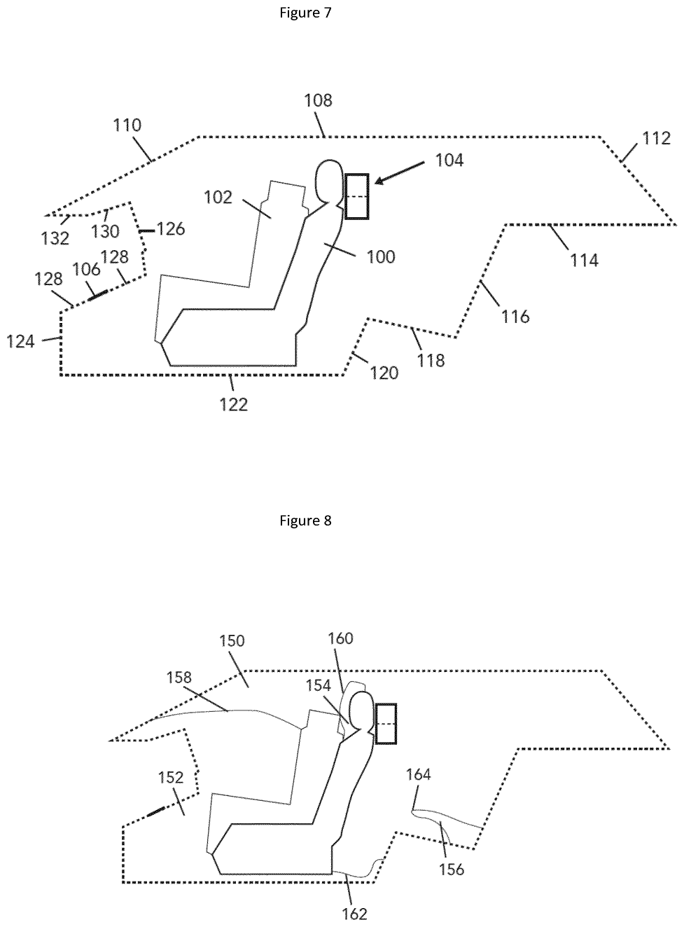

FIG. 7-11 is described below under experiments.

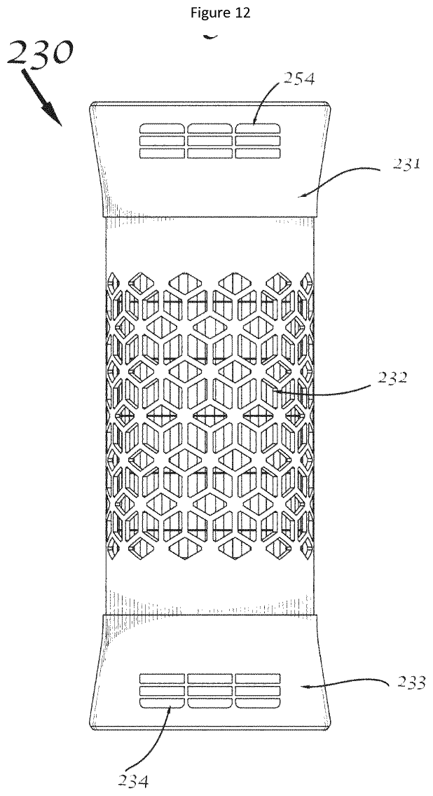

FIGS. 12-15 illustrates a preferred embodiment of the air cleaning device of the present invention as a side view, a partly cross-sectional view, a view of the diffuser module from the top and sides, as well as cross sectional views of fins and location of fins.

FIG. 12 illustrates a preferred air cleaning device (230) of the present invention having a housing with end caps (231, 233) containing the diffuser modules, and a mid-section cover containing the air cleaning unit. Air inlets (232) for drawing air, such as ambient air, into the air cleaning unit are located in the mid-section cover, and air outlets (234, 254) are located in the end caps (231, 233) for providing cleaned air to a specified zone, such as a human nose and/or mouth.

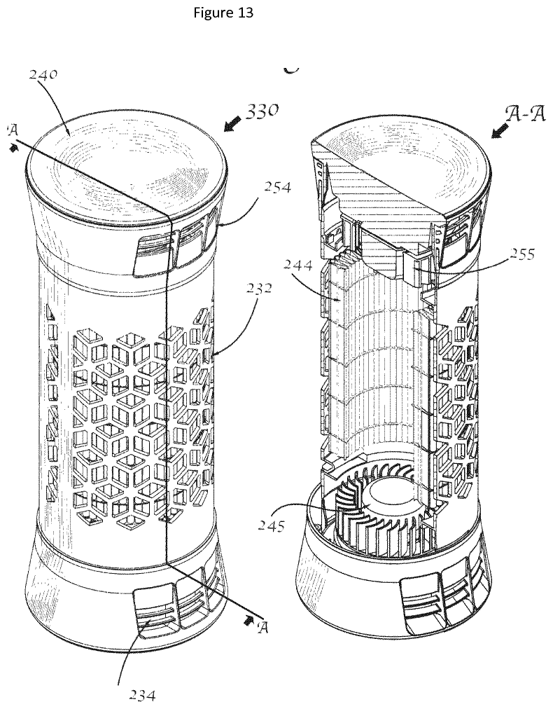

FIG. 13 illustrates an isometric view of the preferred air cleaning device (330) of the present invention having a housing with an end cap (240), and a corresponding end cap opposite end cap 240) containing the diffuser module, and a mid-section cover containing the air cleaning unit. Air inlets (232) for drawing air, such as ambient air, into the air cleaning unit are located in the mid-section cover, and air outlets (234, 254) are located in the end caps (240) for providing cleaned air to a specified zone. A-A defined a part cross section view wherein two fans (245, 255) are located adjacent the filter (244) of the air cleaning unit wherein the ambient air will be sucked into the device through the inlets (232) and through the filter (244) and further to the diffuser modules located in the end caps (240).

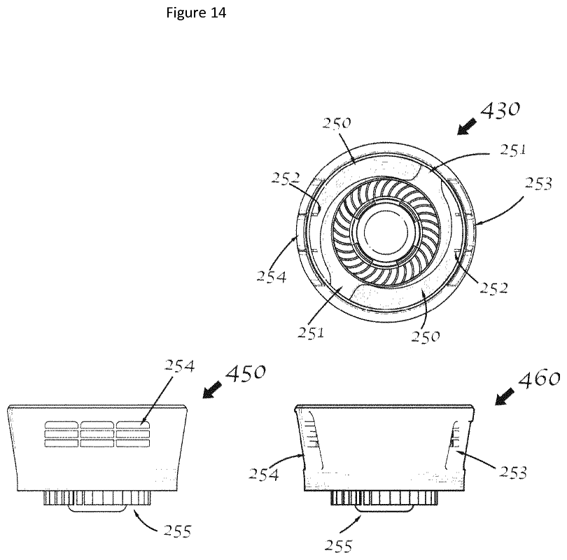

FIG. 14 illustrates a diffuser module of the present invention located in end caps (430, 450, 460). The diffuser module end cap top view (430) is shown with an air channel (250) having a curved and narrowing cross section wherein the narrowing part ends at outlets (253, 254) with vertical fins (252). The air being transported through the filter and into the diffuser module (430) meet a flow separator (251) and is directed into the curved and narrowing air channel (250) and further out through the outlets (253, 254) wherein the outlets are further modified by having fins that have a desired angle to direct the cleaned air to a desired location, such as a human breathing zone. The diffuser module end cap front view and side view (450, 460) has outlets (253, 254) located at opposite sides of the end caps (460) having a circular form, and wherein the fan (255) is adjacent the diffuser module.

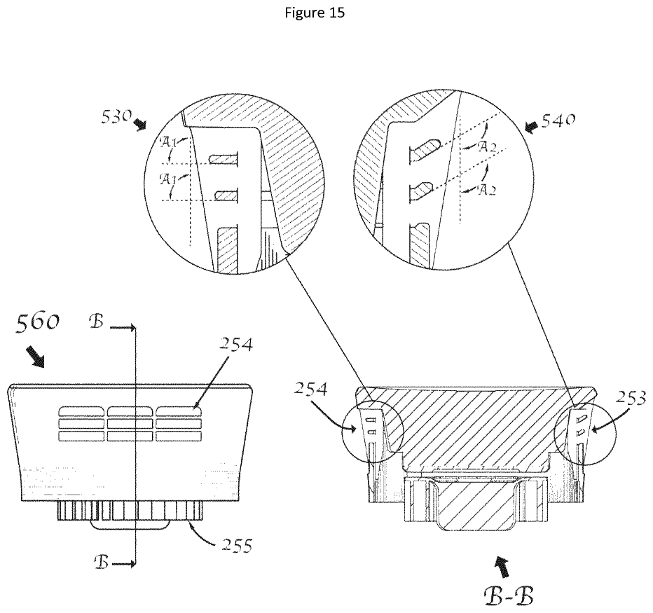

FIG. 15 illustrates a diffuser module of the present invention (560) as seen in FIG. 14 with a fan (255) located adjacent the diffuser module in the end cap (560) having air outlets (254) wherein a cross section B-B is defined. B-B is seen with a more clear illustration of air outlet with angled horizontal fins (243, 254), wherein the sections with the angled fins (530, 540) are enlarged so that the specific angles are seen. One part of the diffuser module (530) has angled horizontal fins (A1) so that the cleaned air streams leaves the diffuser module at an angle of 90° relative to the flow of air into the diffuser module from the air cleaning unit. The opposite part of the diffuser module (540) has angled horizontal fins (A2) so that the cleaned air streams leaves the diffuser module at an angle of more than 90° (such as 120°) relative to the flow of air into the diffuser module from the air cleaning unit.

### EXPERIMENTALS

### Overview

The results presented in this document are obtained by carrying out Computational Fluid Dynamics (CFD) simulations. By using CFD simulation it is possible to understand and analyze flow behavior within a computational domain. The air flow in a 3D geometry of a car cabin (the domain) was studied. The aim was to find out the impact of the design of an air cleaner on providing clean air for people in the car. In the model, the car ventilation is a source of pollution and the air cleaner can remove air pollution. Ideally the source is eliminated, but shutting off completely the air ventilation of a car can cause CO₂ concentrations to rise to levels that cause dizziness and nausea. Therefore, a minimal inlet airflow into the car cabin should be maintained. Due to this ventilation, air pollution from the outside will enter the car cabin. Here, only results are presented where air enters the cabin via the vents at the feet, as this is the preferred way of delivering air in case an in-cabin air cleaner is employed.

### The Domain/Car Geometry

A cross section of the 3D geometry (through the driver's body) can be seen in FIG. 7, where it shows the geometry of car cabin (108, 110, 112, 114, 116, 118, 120, 122, 124, 126, 128,132), a mannequin (driver) (102), his seat (100), air cleaner (104) and car ventilation inlet (106). The geometry of car includes, car roof (108), windshield (110), rear windshield (112), rear deck (114), back seat (116, 118, 120), floor (122), area below dashboard (near to pedals) (124), dashboard (126, 128, 130) and area on the dashboard (132). The car ventilation inlet (106) is a part of the lower surface of the dashboard (128) in front of both front car seats (two in total). Each of them has a dimension of 0.07 m by 0.17 m. Air enters the car at a total air flow rate of 20 m³/h via these two inlets.

The car ventilation outlet is a part of the surface on the dashboard (132), there is one outlet which is located in the center of the car with an area of 0.0236 m². Due to its location in the center, the outlet is not visible in the presented FIGS. 7-11 because the figures show cross sections through the driver's seat.

The 3D car cabin geometry contains an air volume of 2.47 m³. The maximum height of the car cabin is 1.11 m (between roof (108) and floor (122)), the maximum length is 2.9 m (between front windshield and rear windshield) and maximum width is 1.52 m (between left and right side of the 3D car cabin geometry).

The air cleaner (104) has a length of 0.1 m (horizontal 136), width of 0.3 m (not shown in FIG. 7) and height of 0.2 m (vertical 134). There are two clean air exhausts on both sides of the air cleaner (140) with dimensions of 0.1 m by 0.1 m. Also, there is an inlet into the air cleaner with dimension of 0.3 m by 0.2 m (134). The overall flow rate through the air cleaner is 40 m³/h. Air is sucked into the device by above mentioned inlets (134) and blown out by two outlets on the sides of the air cleaner (140).

### Simulation

In the simulations, Navier-stokes equations were solved in order to model flow behavior. A K-epsilon RANS turbulence model was applied to simulate turbulence behavior of this flow. The air pollution distribution was modeled as a diluted species which carries along with the background modeled air flow. The diffusion coefficient of carbon dioxide in air was used (0.16679 cm²/s) to simulate the diffusion of pollution in air. Diffusion was found to have negligible impact on pollution distribution in the system in comparison with convection. In this simulation, the incoming air into the car cabin (through car ventilation inlet 106) was assumed to be 100% polluted by 1 mol/m³. (This means 1 mole of pollution enters the car cabin along with 1 m³ of incoming air.) In principle, any concentration can be modeled this way as long as the pollutant can be considered a diluted species which is generally true for all types of urban air pollution, because the pollution does not affect the airflow pattern. The air cleaner exhaust flow (through the air cleaner 140) is assumed to be completely clean, i.e. 0% of incoming concentration. Air and remaining pollution leave the system through the car ventilation outlet (which is a part of the surface on dashboard (132)).

Gravity has been considered in these simulations and all the presented results are steady state results. All the simulations were carried out for reference pressure of 1 atm and reference temperature of 293.15K. Omitting the effect of variable temperature is a reasonable simplification if assuming a car operating after its warm-up period.

### Results

### Base Case 1

Car cabin is 100% polluted at the start of the simulation, before turning on the air cleaners.

In the first simulation, a base case was simulated where the air cleaner has 4 exhaust (in up (136) (area of 0.03 m²), down (138) (area of 0.03 m²), right, and left (both on 104) (each one has area of 0.02 m²) directions) and all of them direct flow normally outward. This is referred to as a base case, since the airflow is not personalized or directed in a specific manner.

In this case the air cleaner cannot deliver clean air far from the air cleaner to the driver (and passengers) because air is recirculated around the air cleaner.

FIG. 8 shows concentration results for this case. Lines (158, 160, 162, 164) represents where pollution is exactly 50% of the inlet concentration. Area (150) shows where the pollution concentration was reduced by more than 50%. In areas (152, 154, 156) less than 50% of the pollution was reduced.

As it can be seen the incoming air from car ventilation inlets (106) (which is polluted by particles and NOx but doesn't have CO2), accumulates in the front part of the car (152). This area carries more than 50% of the inlet concentration. The pollution concentration in the breathing zone of the driver is about 50% compared to the inlet concentration.

On the other hand, the air from the car ventilation doesn't reach the air cleaner properly (it reaches to line (158) and (162) and the air cleaner instead sucks in air that is clean already, limiting its efficiency. Air entering the car through its ventilation system inlet (106) (which is clean low in CO2) leaves the car cabin directly via the outlet in front of the car cabin (on surface 132) without being used.

Thus, this set-up causes a poor efficiency in providing clean air for people.

### Base Case 2

The second result demonstrates another case without directing the flow. In this case, the air cleaner has two outlets on sides (140) (each one has area of 0.01 m²).

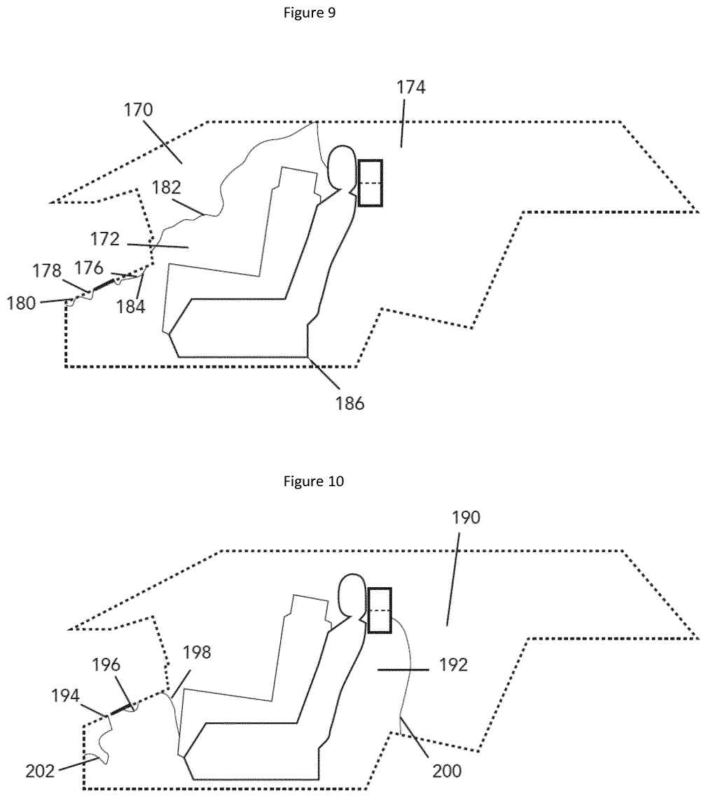

FIG. 9 shows the concentration results for this case. Lines (182, 184, 186) represents where the pollution is exactly 50% (relative to the inlet air). Areas of (170) & (174) show where more than 50% of the pollutants were removed. In areas (172) & (176) the air pollution concentration is more than 50% compared to the inlet concentration.

Since the flow rate of the air cleaner was kept constant in all of the simulations (at 40 m³/h), decreasing the outlet area of the air cleaner increases the outlet velocity. Clean air is pushed to the left and right sides, i.e. clean air is delivered to the windows and doors (where it is not needed). Therefore, the zone near the driver remains polluted (172). Also, the air cleaner doesn't suck polluted air from car ventilation system in order to clean it and deliver it to the passengers. It recirculates air in the back part of car (174) which will eventually cause increment of CO₂ in this region. Thus, this design works inefficiently as well.

### Personalized Case a=b=30°

In this case the same airflow rate and geometry of air cleaner outlets were used as in base case 2, but the air leaves the air cleaner at an angle of 30 degrees (see definition of angles in main text and (72, 74) in FIG. 5). The results for this case are shown in FIG. 10. Lines (198) and (200) show where the pollution level is 50% with respect to the starting concentration. In area (190) more than 50% of the pollution was removed, and in area (192) less than 50% of the pollution was removed.

The results clearly show that the breathing zone of the driver is in the part of the car with clean air, and that the driver's breathing zone is far from the 50/50 line (198). In this simulation, clean air leaving the air cleaner (140) is pointing toward the front half of the car. It causes a high pressure, region in the front of car and a low pressure in the back half of the car. This pressure difference caused by the personalized air cleaner doesn't allow the airflow form the car ventilation to come toward the driver's face. Polluted air stays around his feet (198). The lower pressure in the back half of the car moves more of the polluted air directly from the car inlet to the back half of the car, where it eventually reaches the air cleaner.

The 50/50 line (200) touches the air cleaner. That means that the air cleaner is sucking in polluted air (in contrast to the base cases 1 and 2 where it sucked in clean air), increasing its overall effectiveness.

This result shows clearly that a personalized car cabin air cleaner can efficiently provide clean air to the car driver and passengers in the back of the car.

### Personalized Case a=b=15°

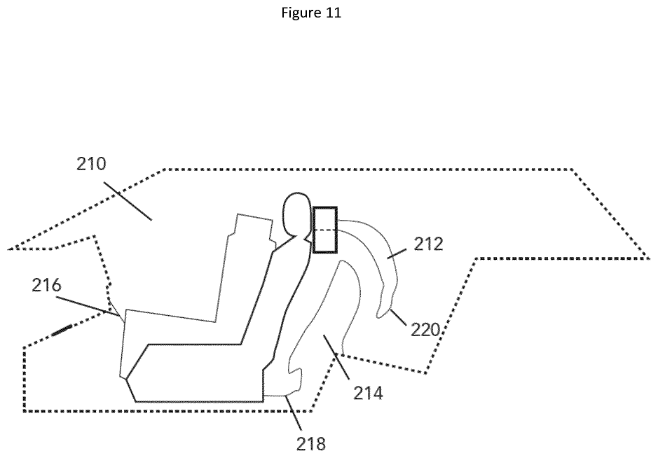

In this case the same airflow rate and geometry of air cleaner outlets were used as in the previous case, but air leaves the air cleaner at an angle of 15 degrees (see definition of angles in main text and (72, 74) in FIG. 5). Results for this case are shown in FIG. 11. Lines (216, 218, 220) show where pollution concentration is 50% with respect to the starting concentration. In area (210) more than 50% of the pollution was removed, and in areas (212) and (214) the pollution concentration is larger than 50% of the starting concentration.

FIG. 11 shows that the personalized car cabin air cleaner does provide a clean air zone around the driver and pushes the polluted air down to the driver's feet (216). Also, the decrease in the angles from 30 to 15 degrees (comparing this case to the previous one) causes an even higher pressure drop between the front and the back of the car cabin. This further improves the overall efficiency of the circulation of polluted air in the bottom of the car and clean air in the top of the car.

Air entering the passes to the back of the car through the space between seat (100) and floor (122), or the space between seat (100)/human (102) and car doors or through the space between the seats.

### Velocities and Simulations at Other Angles

The above mentioned, simulations for a and b between 15 and 30 degrees resulted in velocities that should not cause personal discomfort to the driver or passengers.

In further simulations (e.g. a=b=60 degrees) air leaving the air cleaner might cause personal discomfort for the co-pilot.

All references, including publications, patent applications and patents, cited herein are hereby incorporated by reference to the same extent as if each reference was individually and specifically indicated to be incorporated by reference and was set forth in its entirety herein.

All headings and sub-headings are used herein for convenience only and should not be construed as limiting the invention in any way.

Any combination of the above-described elements in all possible variations thereof is encompassed by the invention unless otherwise indicated herein or otherwise clearly contradicted by context.

Recitation of ranges of values herein are merely intended to serve as a short method of referring individually to each separate value falling within the range, unless other-wise indicated herein, and each separate value is incorporated into the specification as if it were individually recited herein. Unless otherwise stated, all exact values provided herein are representative of corresponding approximate values (e.g., all exact exemplary values provided with respect to a particular factor or measurement can be considered to also provide a corresponding approximate measurement, modified by “about”, where appropriate).

All methods described herein can be performed in any suitable order unless otherwise indicated herein or otherwise clearly contradicted by context.

The terms “a” and “an” and “the” and similar referents as used in the context of describing the invention are to be construed to insert both the singular and the plural, unless otherwise indicated herein or clearly contradicted by context. Thus, “a” and “an” and “the” may mean at least one, or one or more.

The term “and/or” as used herein means each individual alternative as well as the combined alternatives, for instance, “a driver and/or a passenger” is intended to mean the driver alone, the passenger alone, or both the driver and the passenger.

The use of any and all examples, or exemplary language (e.g., “such as”) provided herein, is intended merely to better illuminate the invention and does not pose a limitation on the scope of the invention unless otherwise indicated. No language in the specification should be construed as indicating any element is essential to the practice of the invention unless as much is explicitly stated.

Throughout the description when “selected from” or “selected from the group consisting of” is used it also means all possible combinations of the stated terms, as well as each individual term.

The citation and incorporation of patent documents herein is done for convenience only and does not reflect any view of the validity, patentability and/or enforceability of such patent documents.

The description herein of any aspect or embodiment of the invention using terms such as “comprising”, “having”, “including” or “containing” with reference to an element or elements is intended to provide support for a similar aspect or embodiment of the invention that “consists of”, “consists essentially of”, or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

This invention includes all modifications and equivalents of the subject matter re-cited in the aspects or claims presented herein to the maximum extent permitted by applicable law.

The features disclosed in the foregoing description may, both separately and in any combination thereof, be material for realizing the invention in diverse forms thereof.

1-46. (canceled)

47. An air cleaning device for providing cleaned air to a specified zone comprising:
a) a housing containing an air cleaning unit having an inlet and an outlet, wherein the inlet is adapted to receive ambient air and the outlet is adapted to disperse the cleaned air, wherein the air cleaning unit comprises a filter and a means for driving air over the filter, such as a fan or wind power, wherein the filter is adapted to clean ambient air and
b) a diffuser module having an inlet and an outlet, wherein the inlet of the diffuser module is connected to the outlet of the air cleaning unit, and the outlet of the diffuser module is adapted to direct the cleaned air to the specified zone.

48. The air cleaning device of claim 47, wherein the specified zone at the outlet of the diffuser module is a human breathing zone.

49. The air cleaning device of claim 47, comprising:
a sensor for monitoring motion and adjust or activate the air cleaning device when needed.

50. The air cleaning device of claim 47, wherein the air cleaning unit comprises a gas phase advanced oxidation (GPAO) or a filter, such as a filter selected from the group consisting of an active carbon filter, a gas adsorbing filter, an electrostatic filter, a honeycomb filter, a sponge based filter, and a fabric filter.

51. The air cleaning device of claim 47, wherein the air cleaning unit comprises at least two different filters, wherein one filter is a filter for removing NOx and the other filter is a filter for removing nanoparticles or ultrafine particles.

52. The air cleaning device of claim 47, wherein the air cleaning unit comprises one filter having a dual effect of removing both NOx and nanoparticles and/or ultrafine particles.

53. The air cleaning device of claim 47, wherein the outlet of the diffuser module comprises at least two different air channels adapted to direct cleaned air streams to the specified zone.

54. The air cleaning device of claim 47, wherein the diffuser module comprises a curved and narrowing air channel for directing the cleaned air stream via the air channels to the specified zone.

55. The air cleaning device of claim 54, wherein the air channels comprise at least two fins to help direct the air stream.

56. The air cleaning device of claim 47, wherein the diffuser module is adapted to provide cleaned air extending up to 2 m, such as from 0.1-2 m, in different directions from the outlet of the diffuser module hereby creating the specified zone and/or wherein the diffuser module is adapted to provide cleaned air, wherein the cleaned air leaves the outlet of the diffuser module in a flow direction at an angle that is less than 180 degrees relative to the direction of flow of the ambient air into the inlet of the air cleaning device.

57. The air cleaning device of claim 47, wherein the diffuser module is adapted to provide cleaned air wherein the cleaned air leaves the outlet of the diffuser module in a flow direction at an angle that is less than 90 degree relative to the direction of flow of the ambient air into the inlet of the air cleaning device, such as at an angle from 15 to 30 degrees.

58. The air cleaning device of claim 47, comprising a sensor for monitoring ambient air pollution, clean air or both and adjust or activate the air cleaning device when needed.

59. The air cleaning device of claim 47, wherein the sensor is located inside the housing containing the air cleaning unit.

60. The air cleaning device of claim 47, which is a stand-alone device.

61. The air cleaning device of claim 47, which is a personalized device.

62. The air cleaning device of claim 47, wherein the device is adapted to a car cabin and deliver cleaned air to the whole car cabin.

63. The air cleaning device of claim 47, wherein the device is adapted to a car cabin and deliver cleaned air to the breathing zone of a driver and/or a passenger.

64. The air cleaning device of claim 47, wherein the diffuser module is an integrated part of the air cleaning unit, or the diffuser module is remote from the air cleaning unit and connected via an air tight means of connection, such as plastic tubes.

65. The air cleaning device of claim 47, wherein the air cleaning unit has at least 2 outlets, and a diffuser module is connected to each outlet, providing at least 2 diffuser modules.

66. The air cleaning device of claim 47, wherein the diffuser module is adjustable and adapted to point in any suitable direction.
